(19) United States
(12) Patent Application Publication
(10) Pub. No.: US 2018/0012590 A1
(43) Pub. Date: Jan. 11, 2018

(54) TERMINAL AND CONTROLLING METHOD THEREOF

(71) Applicant: LG ELECTRONICS INC., Seoul (KR)

(72) Inventors: Jeongyun HEO, Seoul (KR); Hyungtae JANG, Seoul (KR); Junghoon CHU, Seoul (KR)

(73) Assignee: LG ELECTRONICS INC., Seoul (KR)

(21) Appl. No.: 15/593,172

(22) Filed: May 11, 2017

(30) Foreign Application Priority Data
Jul. 8, 2016 (KR) 10-2016-0086855

(51) Int. Cl. G10L 13/04; G06F 17/24; G06F 17/27; G06K 9/00

(52) U.S. Cl. CPC G10L 13/043; G06K 9/00671; G06F 17/24; G06F 17/2785

(57) ABSTRACT

Disclosed are a terminal and operating method thereof. The present invention includes determining a linguistic habit of a user based on a terminal use history, outputting an image, recognizing at least one object contained in the outputted image, and outputting a description of the outputted image by an audio corresponding to the determined linguistic habit based on the recognized at least one object.

### CROSS-REFERENCE TO RELATED APPLICATIONS

Pursuant to 35 U.S.C. §119(a), this application claims the benefit of earlier filing date and right of priority to Korean Application No. 10-2016-0086855, filed on Jul. 8, 2016, the contents of which are hereby incorporated by reference herein in its entirety.

### BACKGROUND OF THE INVENTION

### Field of the Invention

The present invention relates to a terminal, and more particularly, to a terminal and controlling method thereof. Although the present invention is suitable for a wide scope of applications, it is particularly suitable for providing an audio description of an image.

### Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Recently, as an image recognition technology is developed, an application for providing a description of an image appears and may provide persons, who have difficulty in recognizing things like visually-handicapped persons, with an audio description indicating what kind of objects are taken in photos.

However, since such an image or thing recognition technology provides only an audio description of a lexical meaning of a recognized object, it may cause a problem that such a technology fails to reflect linguistic habits or interests of a user having captured an image, a user having uploaded an image, or a user watching an image.

Thus, the audio description through the image or thing recognition technology is limited to capability of providing fragmentary information only.

### SUMMARY OF THE INVENTION

Accordingly, embodiments of the present invention are directed to a terminal and controlling method thereof that substantially obviate one or more problems due to limitations and disadvantages of the related art.

One object of the present invention is to provide a terminal and controlling method thereof, by which an audio description of an image is provided in a language corresponding to a linguistic habit.

Another object of the present invention is to provide an audio description that reflects image related information and user's opinion.

Further object of the present invention is to provide an interface, by which an audio description of an image can be edited easily and conveniently.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a method of operating a terminal according to one embodiment of the present invention may include determining a linguistic habit of a user based on a terminal use history, outputting an image, recognizing at least one object contained in the outputted image, and outputting a description of the outputted image by an audio corresponding to the determined linguistic habit based on the recognized at least one object.

In another aspect of the present invention, as embodied and broadly described herein, a terminal according to one embodiment of the present invention may include a memory, an audio output unit configured to output an audio, a display configured to output an image, and a controller configured to determine a linguistic habit of a user based on a terminal use history, recognize at least one object contained in the outputted image, and output a description of the outputted image by the audio corresponding to the determined linguistic habit based on the recognized at least one object.

Accordingly, embodiments of the present invention provide various effects and/or features.

First of all, a terminal according to an embodiment of the present invention can provide an audio description of an image in a language corresponding to user's linguistic habit, thereby providing the audio description that reflects a personal tendency.

Secondly, the present invention can provide an audio description which reflects information related to an image and a user's opinion, thereby providing various kinds of informations on the image.

Thirdly, since the present invention can provide an interface capable of editing an audio description of an image, thereby enabling a user to edit the audio description easily and conveniently.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. The above and other aspects, features, and advantages of the present invention will become more apparent upon consideration of the following description of preferred embodiments, taken in conjunction with the accompanying drawing figures.

In the drawings:

FIG. 1 is a block diagram to describe a terminal related to the present invention;

FIG. 2 is a flowchart for a method of operating a terminal according to various embodiments of the present invention;

FIGS. 3 to 7 are diagrams for examples of an audio description of an image depending on user's linguistic habit according to various embodiments of the present invention;

FIG. 8 is a diagram of an icon for selecting a user who becomes a reference to an audio output according to various embodiments of the present invention;

FIGS. 9 to 11 are diagrams for examples of an audio description containing additional information on an image according to various embodiments of the present invention;

FIG. 12 and FIG. 13 are diagrams for examples of a voice output depending on an ambience according to various embodiments of the present invention;

FIGS. 14 to 16 are diagrams for examples of a voice output depending on a character according to various embodiments of the present invention;

FIG. 17 is a diagram for an example of an image description according to various embodiments of the present invention;

FIG. 18 is a diagram for an example of an output of an answer to a question according to various embodiments of the present invention;

FIG. 19 is a diagram for an example of a word change according to various embodiments of the present invention;

FIG. 20 is a diagram for an example of a description order change according to various embodiments of the present invention;

FIG. 21 is a diagram for an example of a description editing according to various embodiments of the present invention;

FIG. 22 is a diagram for an example of a word deletion according to various embodiments of the present invention;

FIG. 23 is a diagram for an example of an additional message according to various embodiments of the present invention;

FIG. 24 is a diagram for an example of a word change for a specific object according to various embodiments of the present invention;

FIG. 25 is a diagram for an example of an audio description of a video according to various embodiments of the present invention;

FIG. 26 is a diagram for an example of an audio output for place information according to various embodiments of the present invention; and

FIG. 27 is a diagram for a notification of an object corresponding to an interest according to various embodiments of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

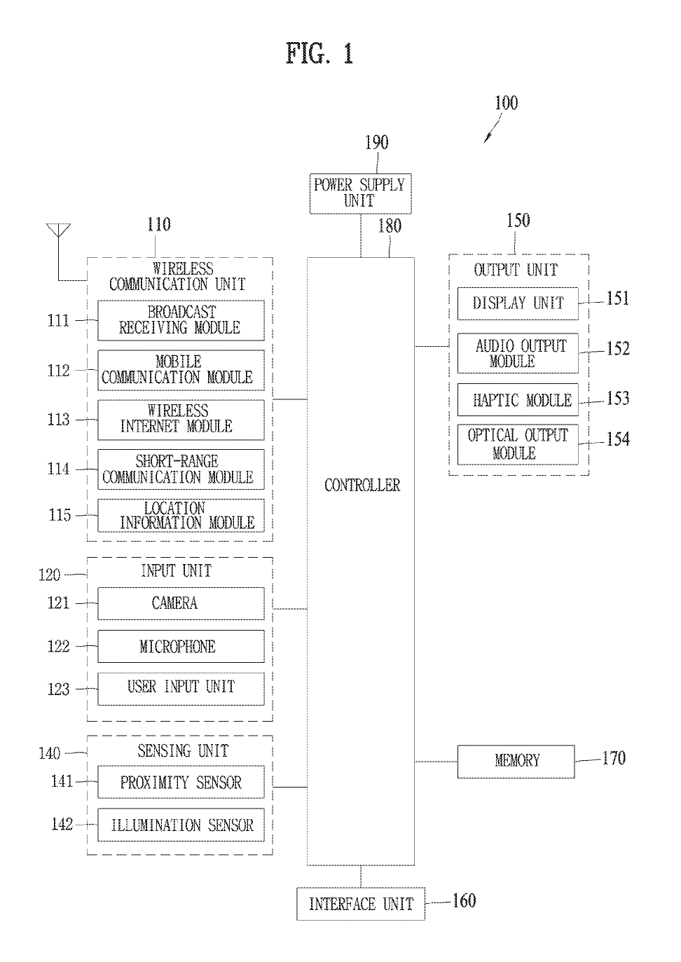

Reference is now made to FIG. 1 is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170. As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supplies the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

A terminal according to various embodiments of the present invention may perform an audio output of a description of an image and also output a description of an image by audio according to a user's linguistic habit. Herein, the user may include one of a user having taken an image, a user having uploaded an image, a user of a terminal configured to output an image, and a preset user. This is described in detail as follows.

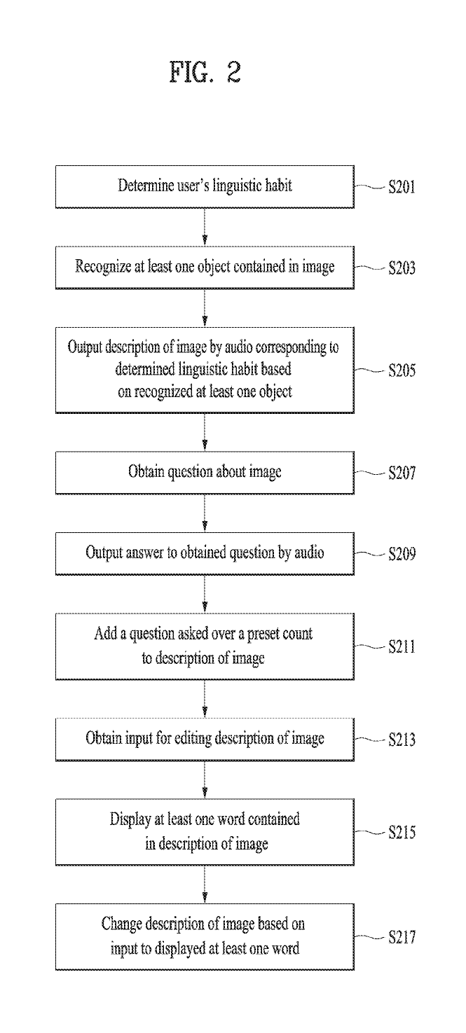

FIG. 2 is a flowchart for a method of operating a terminal according to various embodiments of the present invention.

Referring to FIG. 2, the terminal 100 may determine user's linguistic habit [S201].

For one example, the terminal 100 may determine user's linguistic habit based on a use history of the terminal 100 used by the user of the terminal 100. For instance, the controller 180 of the terminal 100 may determine user's linguistic habit based on substance of a voice call through the terminal 100, a text or sentence inputted to the terminal 100, an image captured through the terminal 100, and a text saved to the terminal 100.

Herein, the user's linguistic habit may include at least one of language, vocabulary, accent, tone, expression, nuance and the like.

For another example, the terminal 100 may receive data of a linguistic habit of a user of terminal 100 from a server (not shown) or a different terminal 100. For instance, if a user having captured an image, a user of a terminal 100 outputting the image and a user having uploaded the image are different from a user of the terminal 100, the terminal 100 may receive data of the corresponding user's linguistic habit from the server or the different terminal 100.

For further example, based on information on a user of the terminal 100, the terminal 100 may determine a linguistic habit corresponding to a tendency of the user of the terminal 100. For instance, based on at least one of a use language, age, gender, area, occupation, education level, interest, usual language use type and the like, the controller 180 of the terminal 100 may determine a linguistic habit corresponding to a user's tendency. Hence, based on information on a user, the terminal 100 may determine user's linguistic habit using probability and/or statistics.

Description of the determination of the linguistic habit of the user of the terminal 100 is exemplary, by which the present invention is non-limited. Hence, various methods may be interchangeably used for the aforementioned linguistic habit determination.

The terminal 100 recognizes at least one object contained in an image [S203], and may output a description of the image by audio corresponding to the determined linguistic habit based on the recognized at least one object [S205].

The terminal 100 may recognize at least one object contained in an image displayed on the display unit 151 or an image saved to the memory 170.

For instance, the terminal 100 extracts an object contained in an image and may then recognize the extracted object. Herein, the object contained in the image may include thing, character and ambience. For one example, the controller 180 may recognize an object contained in an image through an application for object recognition, or may recognize an object contained in an image through communication with a server (not shown) or a different terminal 100. For instance, the terminal 100 may send full or partial data of an image to the server or the different terminal 100, receive recognition information on an object contained in the image, and then recognize the object contained in the image. Herein, in order to recognize the object contained in the image, the server to which the terminal 100 sends the full or partial data of the image may include a server having an engine or application for image recognition.

Based on the recognized at least one object contained in the image, the terminal may output the description of the image by audio, and more particularly, by audio corresponding to the user's determined linguistic habit. Herein, as mentioned in the foregoing description, the user may include one of a user having captured the image, a user having uploaded the image, a user of the terminal outputting the image, and a preset user. Hence, according to a user selection, the settings of the terminal 100, or the settings of the image, the terminal 100 may output the description of the image by audio corresponding to a linguistic habit of one of such users.

Based on user's interest that becomes a reference to an audio output, the terminal 100 may output a description of an image. Hence, based on the user's interest, the terminal 100 may output the description of the image in a language corresponding to the user's linguistic habit.

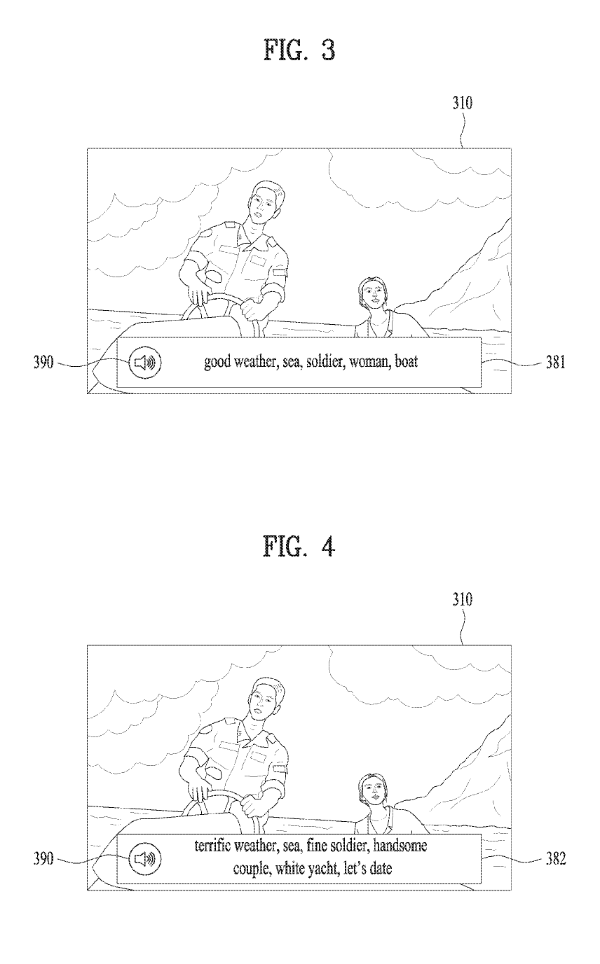

This is described with reference to FIGS. 3 to 7.

FIGS. 3 to 7 are diagrams for examples of an audio description of an image depending on user's linguistic habit according to various embodiments of the present invention.

The terminal 100 according to various embodiments may output a description of an image by audio corresponding to a linguistic habit of a user having captured the image.

Referring to FIG. 3, the terminal 100 may recognize a first image 310 and then determine user's linguistic habit that becomes a reference to an audio description to be outputted. For instance, if a user becoming a reference to an audio description is a first user having captured a first image 310 and a linguistic habit of the first user corresponds to a user who uses a simple and objective language, the terminal 100 may output an audio description based on the simple and objective language for the description of the recognized first image 310. For one example, for the audio description of the recognized first image 310, the controller 180 may construct a word or sentence for an object contained in the recognized first image. The controller 180 may construct the constructed word or sentence as a word or sentence corresponding to the determined linguistic habit of the first user. For instance, the controller may construct ‘good weather, sea, soldier, woman, boat’ as the words for the first image 310. The terminal 100 may display the constructed words on the display unit 151. For instance, the controller 180 may display the constructed words on a recognized word window 381 displayed on the display unit 151 and then display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 381, or by creating a sentence based on the displayed words. For instance, the controller 180 may output ‘good weather, sea, soldier, woman, boat’ corresponding to the words included in the recognized word window 381 or a sentence ‘Soldier and woman are on a boat in the sea of good weather’, by audio.

The terminal 100 according to various embodiments may output a simple substance only or a detailed substance when outputting a description of an image by audio.

For instance, for the first image 310, the terminal 100 may output a simple description like ‘Soldier and woman are on a boat’, or a detailed description like ‘Soldier and woman are on a boat, in the sea of good weather’.

The terminal 100 according to various embodiments may output a description of an image by audio corresponding to a linguistic habit of a user having uploaded the image.

Referring to FIG. 4, the terminal 100 may recognize a first image 310 and then determine user's linguistic habit that becomes a reference to an audio description to be outputted. For instance, if a user becoming a reference to an audio description is a second user having uploaded the first image 310 and a linguistic habit of the second user corresponds to a user who uses a language corresponding to a young male, the terminal 100 may output an audio description based on the language habit popularly used by young males. For one example, for the audio description of the recognized first image 310, the controller 180 may construct a word or sentence for an object contained in the recognized first image. The controller 180 may construct the constructed word or sentence as a word or sentence corresponding to the determined linguistic habit of the second user. For instance, the controller may construct ‘terrific weather, sea, fine soldier, handsome couple, white yacht, let's date’ as the words or sentence for the first image 310. The terminal 100 may display the constructed words on the display unit 151. For instance, the controller 180 may display the constructed words on a recognized word window 382 displayed on the display unit 151 and also display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 382, or by creating a sentence based on the displayed words. For instance, the controller 180 may output ‘terrific weather, sea, fine soldier, handsome couple, white yacht, let's date’ corresponding to the words included in the recognized word window 382 or a sentence ‘A handsome couple including a fine soldier are on a white yacht on the sea in the terrific weather. Let's date.’, by audio.

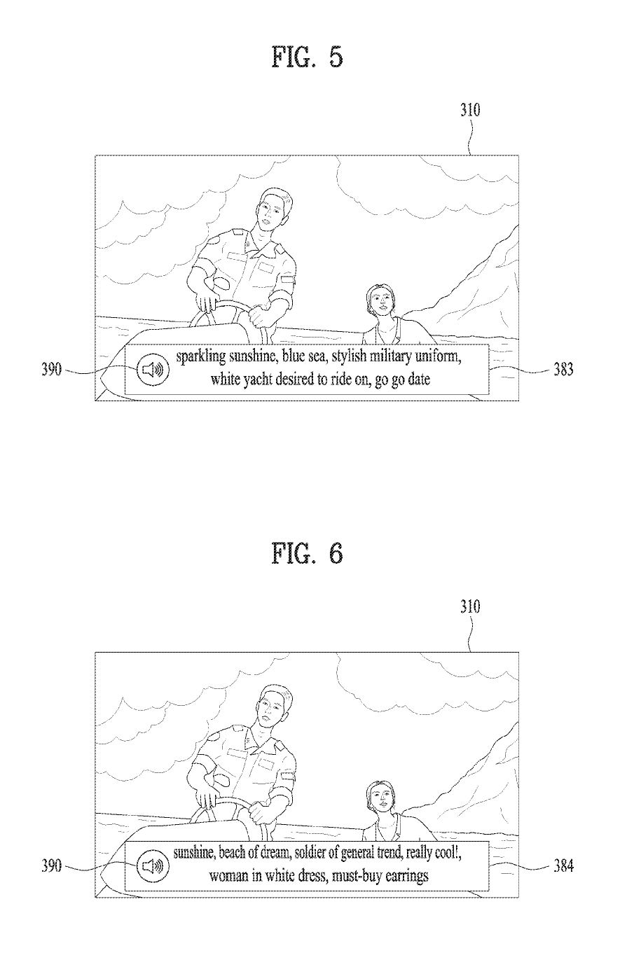

Referring to FIG. 5, the terminal 100 may recognize a first image 310 and then determine user's linguistic habit that becomes a reference to an audio description to be outputted. For instance, if a user becoming a reference to an audio description is a third user having uploaded the first image 310 and a linguistic habit of the third user corresponds to a user who uses a language corresponding to a young female, the terminal 100 may output an audio description based on the language habit popularly used by young females. For one example, for the audio description of the recognized first image 310, the controller 180 may construct a word or sentence for an object contained in the recognized first image. The controller 180 may construct the constructed word or sentence as a word or sentence corresponding to the determined linguistic habit of the third user. For instance, the controller may construct ‘sparkling sunshine, blue sea, stylish military uniform, white yacht desired to ride on, go go date’ as the words or sentence for the first image 310. The terminal 100 may display the constructed words on the display unit 151. For instance, the controller 180 may display the constructed words on a recognized word window 383 displayed on the display unit 151 and also display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 382, or by creating a sentence based on the displayed words. For instance, the controller 180 may output ‘sparkling sunshine, blue sea, stylish military uniform, white yacht desired to ride on, go go date’ corresponding to the words included in the recognized word window 383 or a sentence ‘A man wearing a stylish military uniform is on a white yacht desired to ride on the blue sea under sparking sunshine. Go go date.’, by audio.

Thus, despite the same image 310, the terminal 100 according to various embodiments can output an audio description corresponding to a linguistic habit of a user having uploaded the image depending on the user having uploaded the image.

The terminal 100 according to various embodiments can output a description of an image by audio corresponding to a language habit of a user of the terminal 100 that outputs the image.

Referring to FIG. 6, the terminal 100 may recognize a first image 310 and then determine user's linguistic habit that becomes a reference to an audio description to be outputted. For instance, if a user becoming a reference to an audio description is a fourth user who is a user of the terminal 100 currently outputting the first image 310 and a linguistic habit of the fourth user corresponds to a user who uses a language corresponding to a teenage female, the terminal 100 may output an audio description based on the language habit popularly used by teenage females and interest of the fourth user. For one example, for the audio description of the recognized first image 310, the controller 180 may construct a word or sentence for an object contained in the recognized first image. The controller 180 may construct the constructed word or sentence as a word or sentence corresponding to the determined linguistic habit of the fourth user. For instance, the controller may construct ‘sunshine, beach of dream, soldier of general trend, really cool!, woman in white dress, must-buy earrings’ as the words or sentence for the first image 310. In this case, the earrings may be a word according to the interest of the fourth user. The terminal 100 may display the constructed words on the display unit 151. For instance, the controller 180 may display the constructed words on a recognized word window 384 displayed on the display unit 151 and also display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 382, or by creating a sentence based on the displayed words. For instance, the controller 180 may output ‘sunshine, beach of dream, soldier of general trend, really cool!, woman in white dress, must-buy earrings’ corresponding to the words included in the recognized word window 384 or a sentence ‘There is a really cool soldier of general trend on a beach of dream under full sunshine, and a woman in white dress wears must-buy earrings.’, by audio.

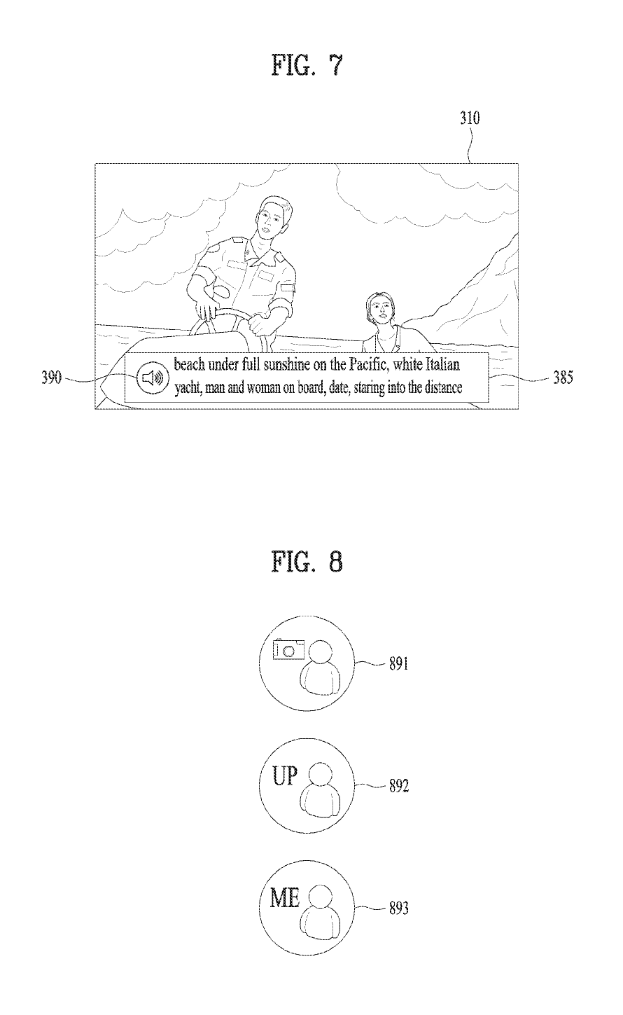

Referring to FIG. 7, the terminal 100 may recognize a first image 310 and then determine user's linguistic habit that becomes a reference to an audio description to be outputted. For instance, if a user becoming a reference to an audio description is a fifth user who is a user of the terminal 100 currently outputting the first image 310 and a linguistic habit of the fifth user corresponds to a user who uses a language corresponding to a male in fifties, the terminal 100 may output an audio description based on the language habit popularly used by males in fifties and a detailed language description corresponding the linguistic habit of the fifth user. For one example, for the audio description of the recognized first image 310, the controller 180 may construct a word or sentence for an object contained in the recognized first image. The controller 180 may construct the constructed word or sentence as a word or sentence corresponding to the determined linguistic habit of the fifth user. For instance, the controller may construct ‘beach under full sunshine on the Pacific, white Italian yacht, man and woman on board, date, staring into the distance’ as the words or sentence for the first image 310. The terminal 100 may display the constructed words on the display unit 151. For instance, the controller 180 may display the constructed words on a recognized word window 385 displayed on the display unit 151 and also display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 382, or by creating a sentence based on the displayed words. For instance, the controller 180 may output ‘beach under full sunshine on the Pacific, white Italian yacht, man and woman on board, date, staring into the distance’ corresponding to the words included in the recognized word window 385 or a sentence ‘Man and woman are on a white Italian yacht near a beach under full sunshine on the Pacific. Two persons on a date are staring into the distance.’, by audio.

Thus, despite the same image 310, the terminal 100 according to various embodiments may output an audio description corresponding to a linguistic habit of a user of the outputting terminal 100 depending on a user of the outputting terminal 100. And, the terminal 100 according to various embodiments may output a description of an image, which reflects user's interest, by audio.

Meanwhile, as mentioned in the foregoing description, the terminal 100 may output a description of an image in a language corresponding to a linguistic habit of a user becoming a reference of an audio output, and may also receive an input for selecting the user becoming the reference of the audio output. For instance, the terminal 100 displays an icon indicating a user becoming a reference of an audio output and outputs the description of the image in a language corresponding to a linguistic habit of a user corresponding to the selected icon. This is described with reference to FIG. 8.

FIG. 8 is a diagram of an icon for selecting a user who becomes a reference to an audio output according to various embodiments of the present invention.

Referring to FIG. 8, the terminal 100 may display at least one of a capturer icon 891 for selecting a user having captured an image as a reference to an audio output, an uploader icon 892 for selecting a user having uploaded an image as a reference to an audio output, and a user icon 893 for selecting a user of an image outputting terminal as a reference to an audio output on the display unit 151. The terminal 100 may receive an input for selecting one of the capturer icon 891, the uploader icon 892 and the user icon 893. The terminal 100 may output an audio description of an image as a linguistic habit corresponding to a user corresponding to the inputted icon.

Meanwhile, the terminal 100 may set a preset user as a reference to an audio output, or may set a user, who is set per image, as a reference to an audio output. Moreover, by applying a reference to an audio output, which is set for a specific user, to an image, the terminal 100 may use a set user as a reference to an audio output.

Based on an attribute of an object contained in an image, the terminal 100 may output a description of the image by audio. For instance, the terminal 100 classifies objects having the same or similar attribute into a single group and is then able to sequentially describe the objects contained in the same or similar group. For another instance, the terminal 100 may make a description in order of a rate for an object to occupy an image by starting with a high rate. For further instance, the terminal 100 may output an audio description of an image in order of entire ambience, background and object.

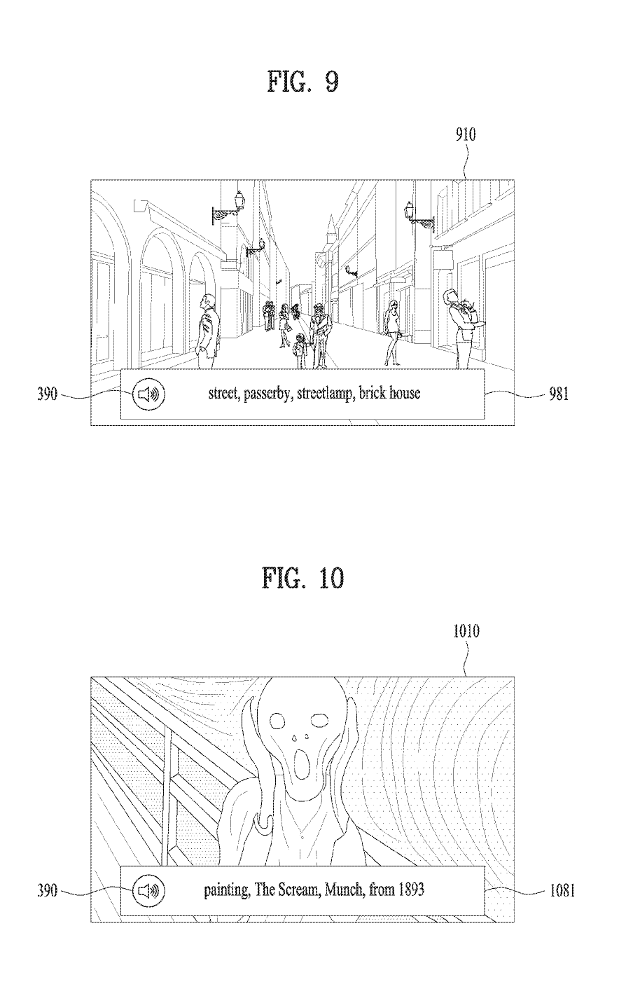

The terminal 100 according to various embodiments may output an audio description of an image by reflecting additional information as well as an objective substance contained in the image if the image becoming a target of the audio description is a popularly famous image. This is described with reference to FIGS. 9 to 11.

FIGS. 9 to 11 are diagrams for examples of an audio description containing additional information on an image according to various embodiments of the present invention.

Referring to FIG. 9, the terminal 100 may recognize a second image 910 and then construct words or sentence for objects contained in the recognized second image 910. For instance, the terminal 100 may construct ‘street, passerby, streetlamp, brick house’ as the words for the second image 910. Herein, since the second image 910 is not a popularly famous image, it may be an image having no additional information. The terminal 100 may display the constructed words on the display unit 151. For instance, the controller 180 may display the constructed words on a recognized word window 981 displayed on the display unit 151 and then display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 981, or by creating a sentence based on the displayed words. For instance, the controller 180 may output ‘street, passerby, streetlamp, brick house’ corresponding to the words included in the recognized word window 981 or a sentence ‘Passersby are on the street, and there are streetlamps and brick houses.’, by audio.

Referring to FIG. 10, the terminal 100 may recognize a third image 1010 and then construct a word or sentence for objects contained in the recognized third image 1010. If the third image 101 is a famous painting, the terminal 100 may obtain additional information on the third image 1010. For instance, the terminal 100 may receive additional information on the third image 1010 from a server (not shown). Hence, the terminal 100 may construct ‘painting, The Scream, Munch, from 1893’ as the words for the third image 1010. The terminal 100 may display the constructed words on the display unit 151. For instance, the controller 180 may display the constructed words on a recognized word window 1081 displayed on the display unit 151 and then display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 1081, or by creating a sentence based on the displayed words. For instance, the controller 180 may output ‘painting, The Scream, Munch, from 1893’ corresponding to the words included in the recognized word window 1081 or a sentence ‘Munch's painting ‘The Scream’ was completed in 1893.’, by audio.

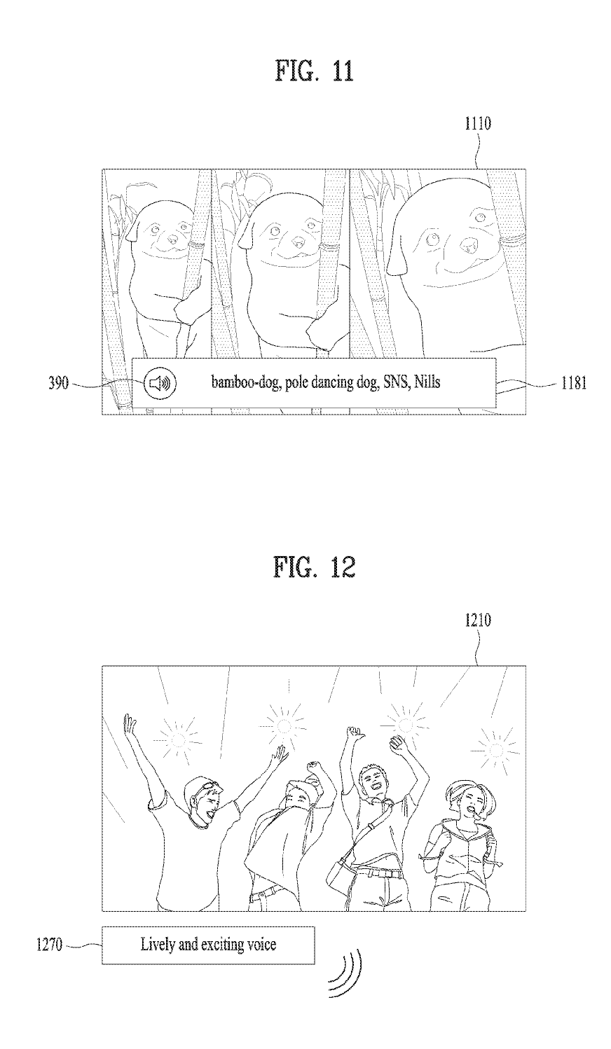

Referring to FIG. 11, the terminal 100 may recognize a fourth image 1110 and then construct words or sentence for objects contained in the recognized fourth image 1110. If the fourth image 111 is a famous image on SNS (social network service), the terminal 100 may obtain additional information on the fourth image 1110. For instance, the terminal 100 may receive additional information on the fourth image 1110 from a server (not shown). Hence, the terminal 100 may construct ‘bamboo-dog, pole dancing dog, SNS, Nills’ as the words for the fourth image 1110. The terminal 100 may display the constructed words on the display unit 151. For instance, the controller 180 may display the constructed words on a recognized word window 1181 displayed on the display unit 151 and then display an audio output icon 390. The audio output icon 390 may include an icon for outputting a description of a recognized image by audio or an icon indicating that the description of the recognized image is currently outputted by audio. The controller 180 may perform the audio output of the description of the image by outputting the words displayed on the recognized word window 1181, or by creating a sentence based on the displayed words. For instance, the controller 180 may output ‘bamboo-dog, pole dancing dog, SNS, Nills’ corresponding to the words included in the recognized word window 1181 or a sentence ‘Photo famous as bamboo-dog or pole dancing dog was shot by Nills.’, by audio.

Thus, the terminal 100 according to various embodiments may output an audio description of an image by reflecting additional information as well as an objective substance contained in the image. In this case, the additional information may include an additional information related to the image or a subjective information created by the public or a group.

The terminal 100 according to various embodiments may output an audio of a voice according to a substance of an image. For instance, the terminal 100 may output an audio of a voice having ambience or tone according to a substance of an image, or an audio of a voice corresponding to a character contained in the image. Moreover, the terminal 100 may output an audio of a voice corresponding to emotion of a character contained in an image. This is described with reference to FIGS. 12 to 16.

FIG. 12 and FIG. 13 are diagrams for examples of an audio output depending on an ambience according to various embodiments of the present invention.

Referring to FIG. 12, the terminal 100 may determine an ambience of a fifth image 1210 based on recognition of at least one object contained in the fifth image 1210. For instance, if the terminal 100 recognizes the fifth image 1210 as containing a plurality of persons having a party, the terminal 100 may determine an ambience of the fifth image 1210 as an exciting ambience or a party ambience. Hence, the terminal 100 may output an audio description of the fifth image 1210 in a lively and exciting voice 1270.

Referring to FIG. 13, the terminal 100 may determine an ambience of a sixth image 1310 based on recognition of at least one object contained in the sixth image 1310. For instance, if the terminal 100 recognizes the sixth image 1310 as a silent woods appearance, the terminal 100 may determine an ambience of the sixth image 3210 as a calm and quiet ambience. Hence, the terminal 100 may output an audio description of the sixth image 1310 in a calm and quiet voice 1370.

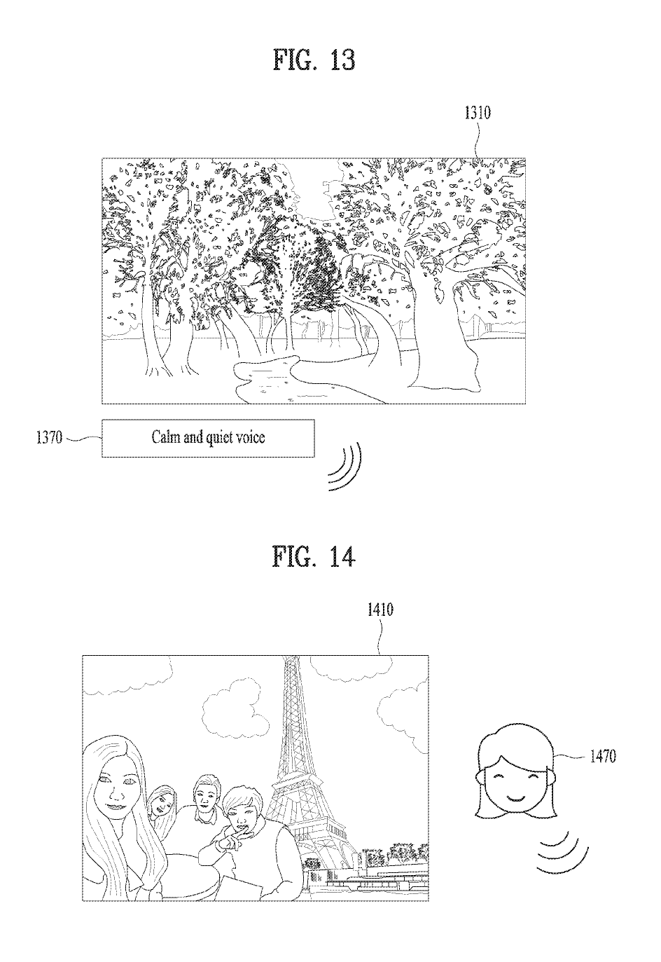

FIGS. 14 to 16 are diagrams for examples of an audio output depending on a character according to various embodiments of the present invention.

Referring to FIG. 14, the terminal 100 may determine a character contained in a seventh image 1410 based on recognition of at least one object contained in the seventh image 1410. For instance, the terminal 100 may determine that a plurality of persons, and more particularly, multiple females are contained in the seventh image 1410. Hence, the terminal 100 may output an audio description of the seventh image 1410 in a female voice 1470.

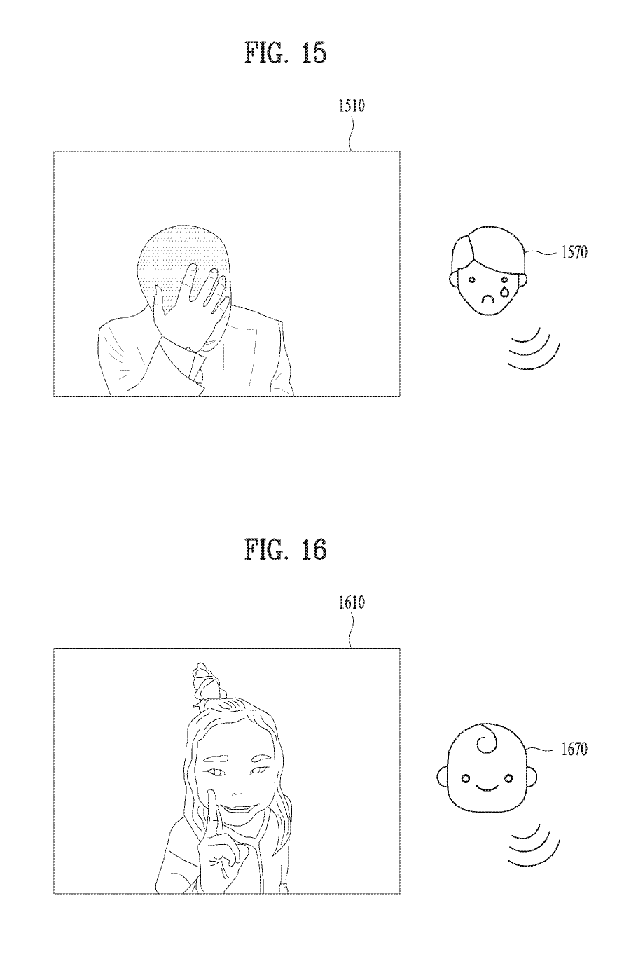

Referring to FIG. 15, the terminal 100 may determine a character contained in an eighth image 1510 based on recognition of at least one object contained in the eighth image 1510. For instance, the terminal 100 may determine that a sad-looking male is contained in the eighth image 1510. Hence, the terminal 100 may output an audio description of the eighth image 1510 in a sad male voice 1570.

Referring to FIG. 16, the terminal 100 may determine a character contained in a ninth image 1610 based on recognition of at least one object contained in the ninth image 1610. For instance, the terminal 100 may determine that a child is contained in the ninth image 1610. Hence, the terminal 100 may output an audio description of the ninth image 1610 in a child voice 1670.

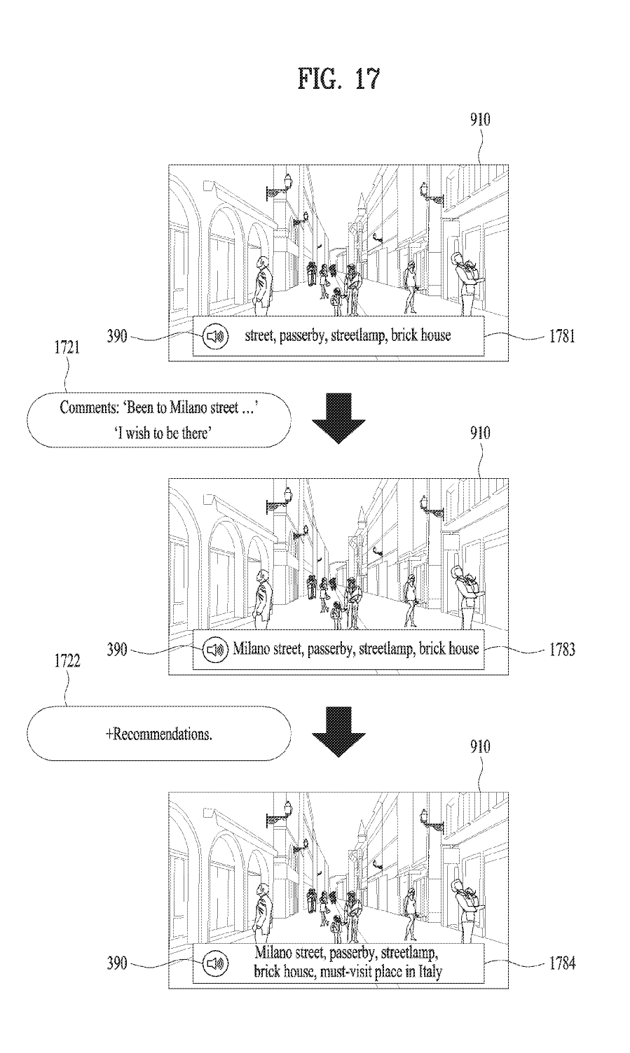

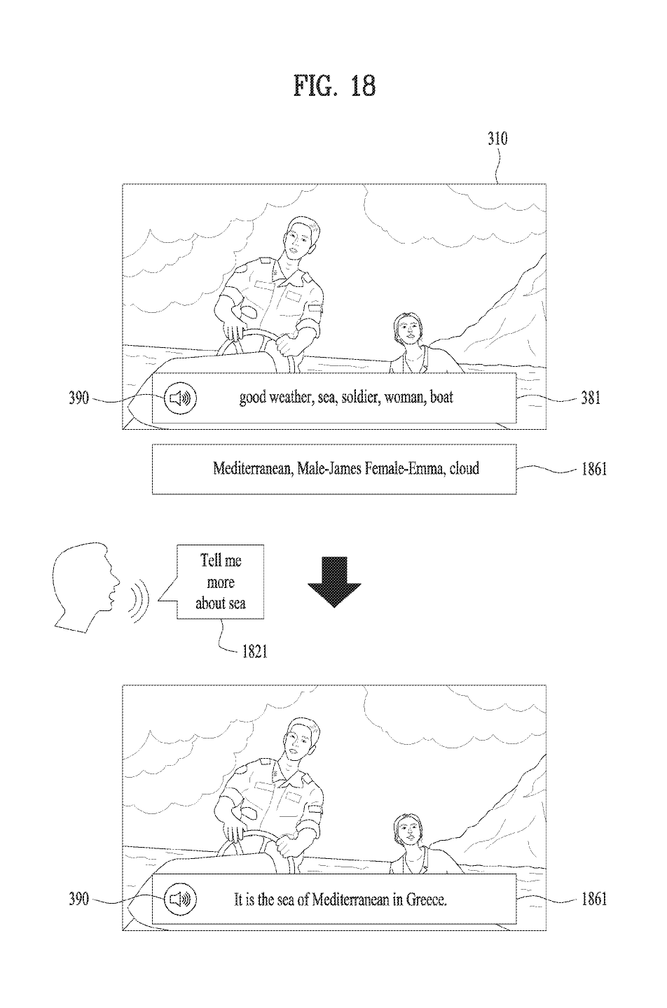

The terminal 100 according to various embodiments may output an audio description of an image by reflecting added information on the image, different user's opinion and the like. This is described with reference to FIG. 17.

FIG. 17 is a diagram for an example of an image description according to various embodiments of the present invention.

Referring to FIG. 17, the terminal 100 may recognize a second image 910 and then construct words or sentence for objects contained in the recognized second image 910. For instance, the terminal 100 may construct ‘street, passerby, streetlamp, brick house’ as the words for the second image 910. The controller 180 may output the words ‘street, passerby, streetlamp, brick house’ included in a recognized word window 1781 or a sentence ‘Passersby are on the street, and there are streetlamps and brick houses.’, by audio. The terminal 100 may obtain comments of other users for the second image 910. Herein, the comments 1721 may include comments inputted on SNS having the second image 910 posted thereon or comments included in a message for the second image 910. The terminal 100 may reflect the obtained comments 1721 in the description of the second image 910. For instance, the terminal 100 may change ‘street’ contained in the recognized word window 1783 for the second image 910 into Milano street. Hence, the controller 180 may output the words ‘Milano street, passerby, streetlamp, brick house’ included in the recognized word window 1783 or a sentence ‘Passersby are on the Milano street, and there are streetlamps and brick houses.’, by audio. The terminal 100 may obtain recommendations 1722 of outer users for the second image 910. Herein, the recommendations 1722 may be obtained through a recommendation function on SNS. The terminal 100 may reflect the obtained recommendations 1722 in the description of the second image 910. Hence, the controller 180 may output the words ‘Milano street, passerby, streetlamp, brick house, must-visit place in Italy’ included in the recognized word window 1784 or a sentence ‘Passersby are on the Milano street, and there are streetlamps and brick houses. It is a must-visit place in Italy.’, by audio.

Thus, the terminal 100 may output an audio description of an image by reflecting added information on the image, outer user's opinions and the like.

FIG. 2 is referred to again.

The terminal 100 may obtain a question about the image [S207] and then out an answer to the question by audio [S209].

After the audio output for the image, the controller 180 of the terminal 100 may obtain a question about the image. For instance, the terminal 100 may obtain user's audio question about the image or a question about the image through a text input. The controller 180 of the terminal 100 may answer to the obtained question based on an object recognized from the image, or based on information obtained based on the recognized object or information failing to be outputted by audio. This is described with reference to FIG. 18.

FIG. 18 is a diagram for an example of an output of an answer to a question according to various embodiments of the present invention.

Referring to FIG. 18, the terminal 100 may construct ‘good weather, sea, soldier, woman, boat’ as words for a first image 310, and may further construct ‘Mediterranean, Male-James, Female-Emma, cloud’. The terminal 100 may display all or some of the constructed words on a recognized word window 1861 displayed on the display unit 151 and also display an audio output icon 390. The terminal 100 may not display the ‘Mediterranean, Male-James, Female-Emma, cloud’ 1861 corresponding to some of the constructed words, and may not perform a corresponding audio output. Hence, the terminal 100 may output ‘good weather, sea, soldier, woman, boat’ corresponding to the words included in the recognized word window 381 by audio, and may output ‘Soldier and woman are on a boat on the sea in good weather.’ by audio. The terminal 100 may obtain a question ‘Tell me more about sea’ 1821 for the first image 310. In response to the obtained question 1821, the terminal 100 may create an answer ‘It is the sea of Mediterranean in Greece.’ based on the ‘Mediterranean, Male-James, Female-Emma, cloud’ 1861 corresponding to the partial information failing to be outputted. And, the terminal 100 may display the created answer ‘It is the sea of Mediterranean in Greece.’ on the recognized word window 1861 and may output the created answer by audio.

FIG. 2 is referred to again.

The terminal 100 may add a substance of a question made over a preset count to the description of the image [S211].

If a substance of an answer to the obtained question is repeated over a preset count, the controller 180 of the terminal 100 may add the substance of the answer to the obtained question as a basic description. Hence, the terminal 100 may output the substance of the answer to the obtained question in performing an audio description of the image. Hence, when the description of the image is initially outputted by audio, the terminal 100 may output the added substance by audio as well.

The terminal 100 may obtain an input for editing the description of the image [S213]. The terminal 100 may display at least one word included in the description of the image [S215], or change the description of the image based on an input to the displayed at least one word [S217].

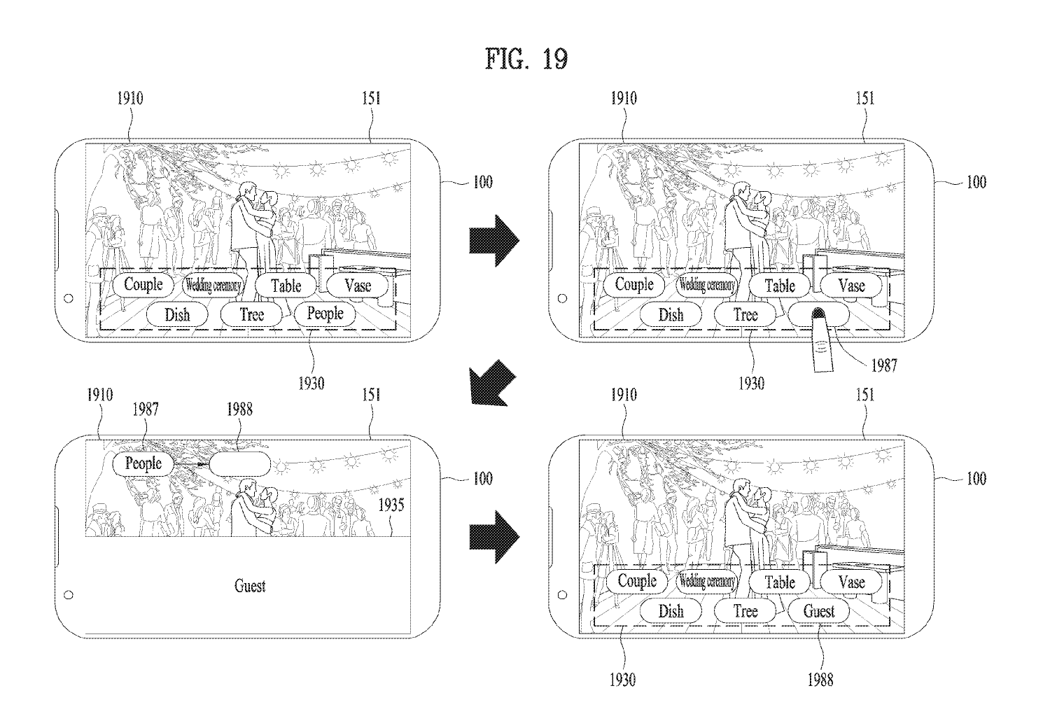

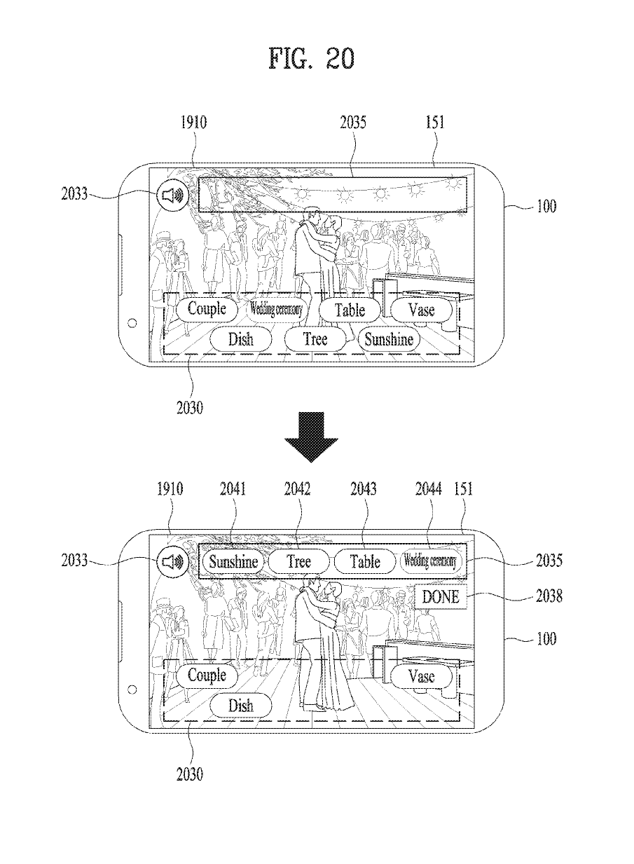

The terminal 100 may change a word included in the audio description of the image or a description order. This is described with reference to FIGS. 19 to 22.

FIG. 19 is a diagram for an example of a word change according to various embodiments of the present invention.

Referring to FIG. 19, the terminal 100 may display a tenth image 1910 on the display 151. The terminal 100 may display words recognized for the tenth image 1910 on a recognized word region 1930. For instance, the terminal 100 can display ‘Couple, Wedding ceremony, Table, Vase, Dish, Tree, People’ corresponding to the words recognized for the tenth image 1910 on the recognized word region 1930. The terminal 100 may obtain an input for modifying the ‘people’ 1987 among the words displayed on the recognized word region 1930. Hence, the terminal 100 may display an editing screen for modifying the ‘people’ 1987 into a new word 1988 on the display unit 151. The terminal 100 may display an input region 1935 for inputting the new word 1988 and change ‘People’ into ‘Guest’ inputted to the input region 1935 into ‘People’. Hence, the terminal 100 may display the ‘Guest’ 1988 instead of the ‘People’ 1987 and also output ‘Guest’ by audio instead of ‘People’ on describing the tenth image 1910.

FIG. 20 is a diagram for an example of a description order change according to various embodiments of the present invention.

Referring to FIG. 20, the terminal 100 may display a tenth image 1910 on the display 151. The terminal 100 may display words recognized for the tenth image 1910 on a recognized word region 2030. For instance, the terminal 100 can display ‘Couple, Wedding ceremony, Table, Vase, Dish, Tree, Sunshine’ corresponding to the words recognized for the tenth image 1910 on the recognized word region 2030. The terminal 100 may display a description window 2035 for inputting a description order for the tenth image 1910. The terminal 100 may output an audio of sequentially describing words inputted to the description window 2035. For one example, in response to an input to an audio output icon 2033, using the words inputted to the description window 2035 sequentially, the terminal 100 can output an audio of describing the tenth image 1910. For instance, if Sunshine 2041, Tree 2042, Table 2043, and Wedding ceremony 2044 are inputted to the description window 2035 sequentially, the terminal 100 can output an audio of describing the tenth image 1910 in order of Sunshine, Tree, Table, and Wedding ceremony. Since the terminal 100 may output an audio of describing the tenth image 1910 using the words included in the description window 2035 only, the terminal 100 may not output a description that uses words failing to be included in the description window 2035 among the words displayed on the recognized word region 2030. Moreover, the terminal 100 may display an end button 2038 for ending an editing on a prescribed region of the display 151. If obtaining an input for selecting the end button 2038, the terminal 100 may end an editing mode for editing the description of the tenth image 1910. And, the terminal 100 may output an audio description of the tenth image 1910 based on the edited substance.

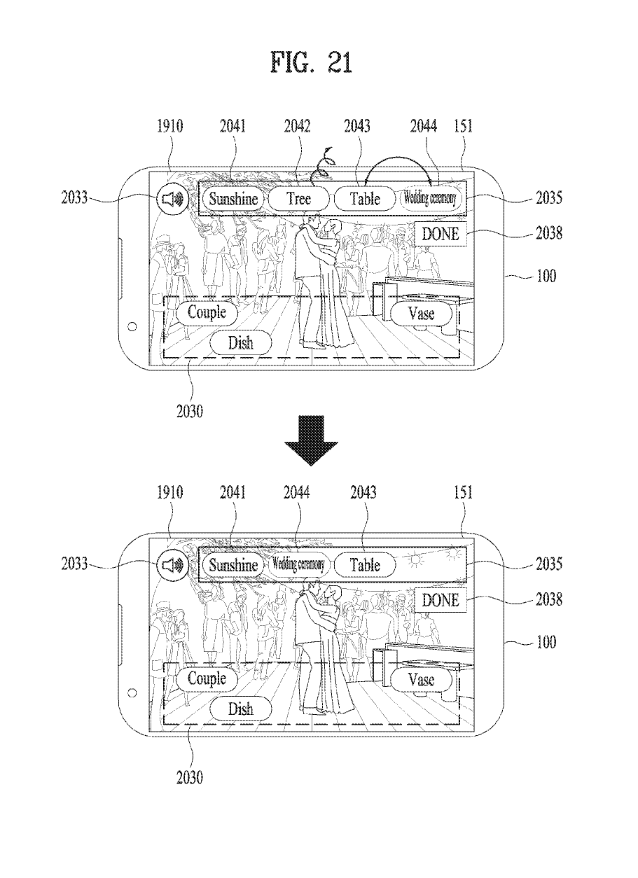

FIG. 21 is a diagram for an example of a description editing according to various embodiments of the present invention.

Referring to FIG. 21, in a state that Sunshine 2041, Tree 2042, Table 2043 and Wedding ceremony 2044 are sequentially inputted to a description window 2035, the terminal 100 may obtain an input for editing an inputted word. For instance, as an input for deleting the Tree 2042 from a description, the terminal 100 may obtain an input of deleting the Tree 2042 from the description window 2035. For one example, the terminal 100 may obtain an input of moving the Tree 2042 out of a region of the display 151, e.g., a swipe or drag & drop input. The terminal 100 may obtain an input for changing a description order between the Table 2043 and the Wedding ceremony 2044. For instance, the terminal 100 may obtain an input of shifting the Table 2043 to locate behind the Wedding ceremony 2044, e.g., a drag & drop input. For another instance, the terminal 100 may obtain an input of shifting the Wedding ceremony 2044 to locate ahead of the Table 2043, e.g., a drag & drop input. Hence, the terminal 100 may display the Sunshine 2041, the Wedding ceremony 2044 and the Table 2043 on the description window 2035 in order, and display an audio for describing the tenth image 1910 using the words inputted to the description window 2035 sequentially. For instance, the terminal 100 may output an audio for describing the tenth image 1910 in order of Sunshine, Wedding ceremony and Table included in the description window 2035. Moreover, as mentioned in the foregoing description, the terminal 100 may display an end button 2038 for ending an editing on a prescribed region of the display 151. If obtaining an input for selecting the end button 2038, the terminal 100 may end an editing mode for editing the description of the tenth image 1910. And, the terminal 100 may output an audio description of the tenth image 1910 based on the edited substance.

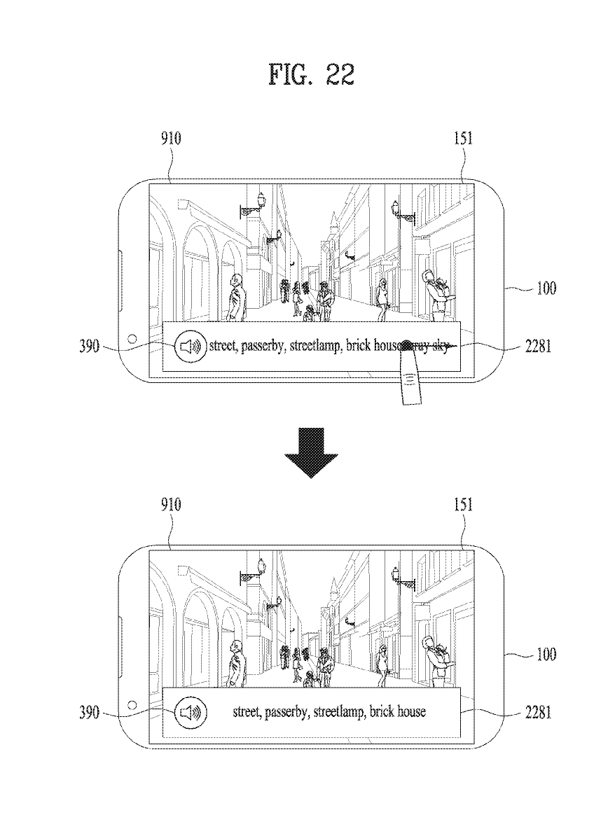

FIG. 22 is a diagram for an example of a word deletion according to various embodiments of the present invention.

Referring to FIG. 22, the terminal 100 may recognize a second image 910 and then construct words or sentence for objects contained in the recognized second image 910. For instance, the terminal 100 may construct ‘street, passerby, streetlamp, brick house, gray sky’ as the words for the second image 910, and display the constructed words on a recognized word window 2281. The terminal 100 may obtain an input for deleting at least one of the words displayed on the recognized word window 2281. For instance, the terminal 100 may obtain an input of swiping the gray sky among the words displayed on the recognized word window 2281 in a right direction. The terminal 100 may delete the swiped gray sky from the recognized word window 2281. The terminal 100 may describe the second image 910 based on the words included in the recognized word window 2281. For instance, the terminal 100 may output ‘street, passerby, streetlamp, brick house’ by audio or ‘Passersby are on the street, and there are streetlamps and brick houses.’, by audio.

The aforementioned input for editing the description of the image and the substance for the description of the image according to the input are provided for examples only, by which the present invention is non-limited. Hence, various input methods and types can be employed as an input for editing a description of an image, and the description of the image can be changed according to the input.

The terminal 100 according to various embodiments may provide an additional or extended description of an image to a specific user only. For instance, the terminal 100 may provide an additional or extended description related to a specific image to a designated user only, or may provide an additional or extended description related to a specific image to a user having an allowed class or authority or a terminal of a user only.

For one example, based on a preset information open range, the terminal 100 may provide an audio description of a specific image according to an information open range allowed for a user reading the image or a user of the terminal. Herein, the preset information open range may be set for each user or class. And, the preset information open range may be determined according to a specific numerical value such as intimacy or the like.

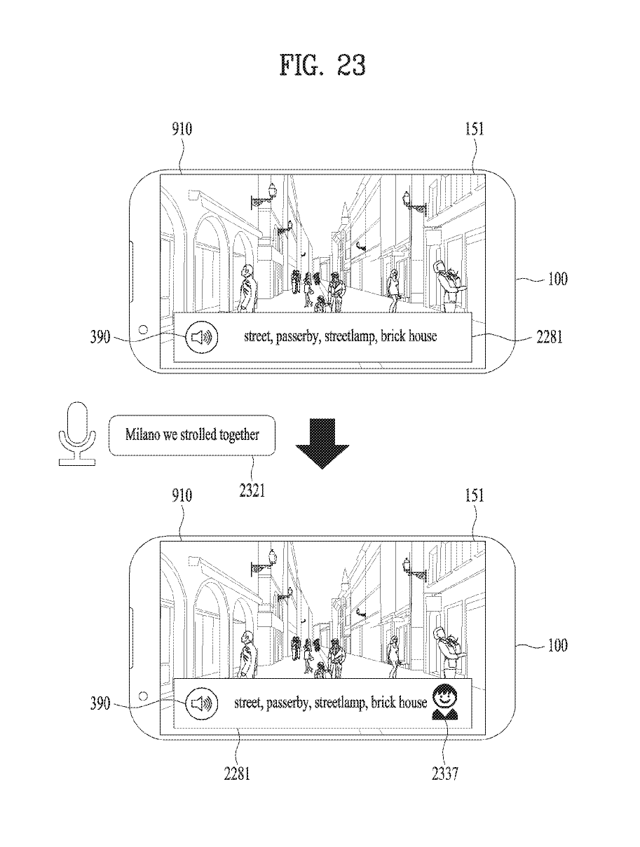

For another example, the terminal 100 may provide an additional or extended description of a specific image to a pre-designated counterpart only, or may provide messages of various types to a pre-designated counterpart only. This is described with reference to FIG. 23.

FIG. 23 is a diagram for an example of an additional message according to various embodiments of the present invention.

Referring to FIG. 23, the terminal 100 may recognize a second image 910 and then construct words or sentence for objects contained in the recognized second image 910. For instance, the terminal 100 may construct ‘street, passerby, streetlamp, brick house’ as the words for the second image 910, and display the constructed words on a recognized word window 2281. The terminal 100 may obtain an additional message for the second image 910, which is to be provided to a specific user only, from one of a user having captured the second image 910, a user having uploaded the second image 910, and a user having forward the second image 910. For instance, the terminal 100 may obtain an additional message ‘Milano we strolled together’ 2321 that is to be provided to a second user only by a first user having uploaded the second image 910. Herein, the additional message may be inputted by audio or through a text input. Hence, when the terminal 100 corresponding to the second user outputs an audio description of the second image 910, it is able to output the obtained ‘Milano we strolled together’ by audio. When the terminal 100 outputs the second image 910, as mentioned in the foregoing description, it may display a recognized word window 2281 and an indicator indicating a presence of an additional message for a specific user. For instance, the terminal 100 may display a second user indicator 2337 on the recognized word window 2281. Hence, a user may confirm that there is an additional message for a specific user, e.g., the second user regarding the second image 910. Herein, the terminal 100 corresponding to the first user may be different from the terminal 100 corresponding to the second user. Thus, the terminal 100 may obtain an additional message for a specific counterpart or a specific user and then provide the obtained additional message to an allowed counterpart or user only through an audio description of a corresponding image.

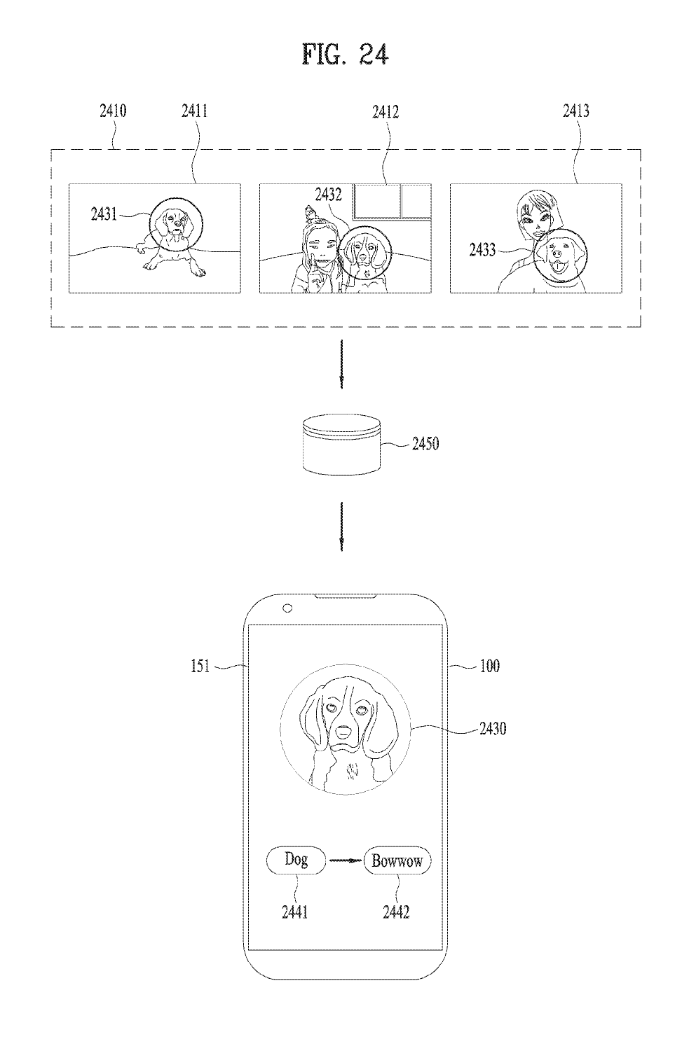

Based on user's word change substance and user's word use substance regarding a specific object, the terminal 100 according to various embodiments may apply a word or keyword frequently used by the user to the specific object. This is described with reference to FIG. 24.

FIG. 24 is a diagram for an example of a word change for a specific object according to various embodiments of the present invention.

Referring to FIG. 24, the terminal 100 may recognize that a specific object (e.g., a dog) contained in each of a plurality of images is captured. For instance, the terminal 100 may recognize the same dogs 2431 to 2433 contained in eleventh to thirteenth images 2411 to 2413 corresponding to a plurality of images 2410, respectively. And, the terminal 100 may recognize that a user uses a keyword or name ‘bowwow’ for the dogs 2431 to 2433 recognized from a plurality of the images 2410. For instance, although ‘dog’ is constructed for the dogs 2431 to 2433 respectively recognized from the eleventh to thirteenth images 2411 to 2413, the terminal 100 can recognize that the user changes ‘dog’ into ‘bowwow’. Hence, the terminal 100 can recognize that the keyword or name ‘bowwow’ is used for each of the recognized dogs 2431 to 2433. The terminal 100 may save the recognized keyword or name to a database 2450. The database 2450 may be included in a server (not shown) or the memory 170 of the terminal 100. Based on the database 2450, the terminal 100 may change the description of the recognized dog 2430 not into a general keyword or name ‘dog’ 2441 but into ‘bowwow’ 2443 used by the user. Hence, the terminal 100 may apply not the ‘do’ 2441 but the ‘bowwow’ 2442 used by the user to the image containing the recognized dog 2430.

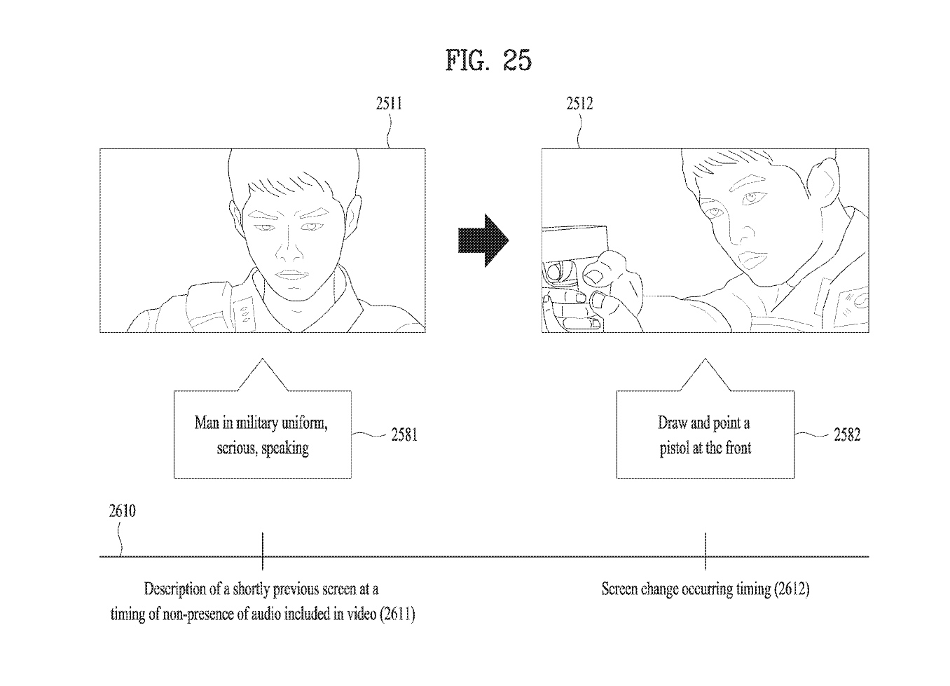

The terminal 100 according to various embodiments may output a description of a moving image or video by audio. For instance, the terminal 100 recognizes a screen change between a previous frame and a current frame from a moving image or video and then outputs a description of the recognized screen change by audio. And, the terminal 100 may make the audio description of the moving image or video by a unit of a screen change occurring timing. In this case, the screen change occurring timing may include a case of a shift or change of an object contained in the moving image or video or a case of a change of a background. Moreover, at a timing of not outputting an audio included in the moving image or video, the terminal may output a description of the moving image or video by audio. If a speed of outputting an audio description of the moving image or video is higher than that of outputting the moving image or video, the terminal 100 may pause the output of the moving image or video and output the audio description of the moving image or video. One embodiment is described with reference to FIG. 25.

FIG. 25 is a diagram for an example of an audio description of a video according to various embodiments of the present invention.

Referring to FIG. 25, the terminal 100 may output an audio description of a video including a first frame 2511 and a second frame 2512. For instance, the terminal 100 recognizes an object for each of the first and second frames 2511 and 2512 and is then able to recognize a screen change between the first and the second frames 2511 and 2512. Hence, the terminal 100 may construct words or sentence such as ‘Man in military uniform, serious, speaking’ 2581 for the first frame 2511 and also construct a sentence such as ‘Draw and point a pistol at the front’ 2582. Regarding a play timing 2610 of the video including the first and second frames 2511 and 2512, the terminal 100 may output an audio description of the first frame 2511 at a timing 2611 of a non-presence of audio included in the video after the output of the first frame 2511, and output an audio description of the second frame 2512 at a screen change occurring timing 2612. Thus, the terminal 100 can output an audio description of a moving image or video at a timing of a non-presence of an audio included in an image, a screen change occurring timing, or the like.

Moreover, in case of repeated images, the terminal may make a description of the images by a repeated timing and then describe that the images are repeated. For instance, for the images having the first and second frames 2511 and 2522 repeated therein, as shown in FIG. 25, the terminal 100 may output such an audio description as ‘Man in military uniform speaks seriously, draws and points a pistol at the front, and the images are repeated.’

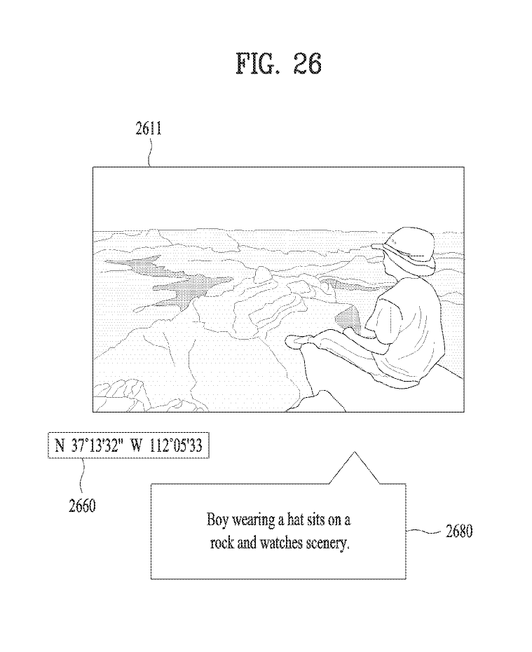

Based on various informations included in an image, the terminal 100 according to various embodiments may output a description of the image by audio. For instance, based on an image shot time, an image shot location, an image shot device information and the like, which are included in an image, the terminal 100 may output a description of the image by audio. This is described with reference to FIG. 26.

FIG. 26 is a diagram for an example of an audio output for place information according to various embodiments of the present invention.

Referring to FIG. 26, the terminal 100 may recognize a fourteenth image 2611 and then construct words or sentence for objects contained in the recognized fourteenth image 2611. For instance, the terminal 100 may construct ‘mountains, boy, hat, rock, scenery, watch’ and the like as the words for the fourteenth image 2611. Based on a GPS data 2660 included in image data of the fourteenth image 2611, the terminal 100 may recognize that a shot location of the fourteenth image 2611 is Grand Canyons. Hence, the terminal 100 may describe the fourteenth image 2611 as Grand Canyons recognized from the GP data 2660 instead of mountains recognized as an image. For instance, the terminal 100 can output such an audio description of the fourteenth image 2611 as ‘Boy wearing a hat sits on a rock and watches scenery.’ 2680. Thus, the terminal 100 may output an audio description of an image based on information included in image data.

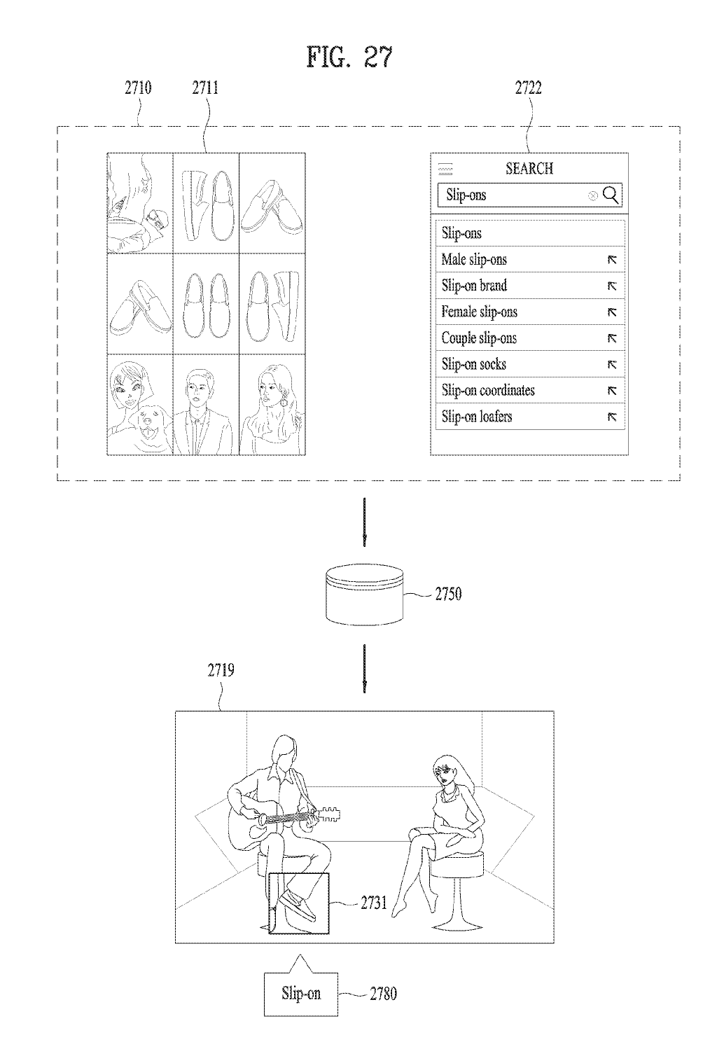

Meanwhile, based on user's terminal use substance, the terminal 100 according to various embodiments may determine user's interest. If an image containing an object corresponding to the determined interest is outputted, the terminal 100 can display the object corresponding to the user's interest in a manner that the displayed object is distinguished from other objects in the outputted image and output an audio for the object corresponding to the user's interest. Herein, the user's terminal use substance may mean various substances related to a terminal use (e.g., screen displayed on a terminal, web search, saved image, saved text, audio, etc.). This is described with reference to FIG. 27.

FIG. 27 is a diagram for a notification of an object corresponding to an interest according to various embodiments of the present invention.

Referring to FIG. 27, based on user's terminal use substance 2710, e.g., each of an image list 2711 and a web search substance 2722 saved to the terminal 100, the terminal 100 may determine that the user is interested in slip-on. The terminal 100 may save a fact that the user is interested in the slip-on to a database 2750. From a screen 2719 displayed on the display unit 151, the terminal 100 may recognize an object corresponding to the slip-on. And, the terminal 100 may perform an enlarged display 2731 of the slip-on corresponding to the recognized object. Moreover, the terminal 100 may output an audio 2780 indicating that the slip-on is contained in the displayed screen 2719. Herein, as an image displayed on the display unit 151, the displayed screen 2719 may include various screens according to a use of the terminal 100 like a web browser screen, a camera shot screen and the like as well as a screen for a content. Thus, the terminal 100 determines user's interest. If an object corresponding to the determined interest is displayed, the terminal 100 may indicate that the object corresponding to the determined interest is displayed, by video and audio.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A method of operating a terminal, the method comprising:
determining a linguistic habit of a user based on a terminal use history;
displaying an image on a display;
recognizing at least one object contained in the displayed image; and
outputting a description of the displayed image by an audio corresponding to the determined linguistic habit based on the recognized at least one object.

2. The method of claim 1, wherein determining the linguistic habit of the user comprises determining the linguistic habit of one selected from the group consisting of a user having captured the image, a user having uploaded the image, and a user of the terminal on which the image is displayed.

3. The method of claim 1, wherein recognizing the at least one object contained in the displayed image comprises:
recognizing the at least one object contained in the displayed image; and
obtaining a word corresponding to each of the recognized at least one object.

4. The method of claim 3, wherein outputting the description of the displayed image comprises:
creating a sentence for the description of the displayed image based on the obtained word; and
outputting the created sentence by the audio corresponding to the determined linguistic habit.

5. The method of claim 3, further comprising displaying the obtained word on a prescribed region of the displayed image.

6. The method of claim 1, wherein determining the linguistic habit of the user comprises determining the linguistic habit of the user based on at least one selected from the group consisting of a call substance, a text substance, a memo substance, a played content substance, a shot image and a saved image of the user using the terminal.

7. The method of claim 1, further comprising:
obtaining a question about the displayed image; and
outputting an answer to the obtained question by the audio.

8. The method of claim 7, further comprising adding a substance questioned over a predetermined count to the description of the image.

9. The method of claim 1, further comprising:
recognizing an input received for editing the description of the displayed image;
displaying at least one word included in the description of the displayed image; and
changing the description of the image based on an input applied to the displayed at least one word.

10. The method of claim 9, wherein changing the description of the image comprises:
changing an order of the description of the displayed image based on the input applied to the displayed at least one word; and
deleting a selected word from the description of the displayed image based on the input applied to the displayed at least one word.

11. A terminal, comprising:
a memory;
an audio output unit;
a display; and
a controller configured to:
determine a linguistic habit of a user based on a terminal use history;
cause the display to display an image;
recognize at least one object contained in the displayed image; and
cause the audio output unit to output a description of the displayed image by an audio corresponding to the determined linguistic habit based on the recognized at least one object.

12. The terminal of claim 11, wherein the controller is further configured to determine the linguistic habit of one selected from the group consisting of a user having captured the image, a user having uploaded the image and a user of the terminal on which the image is displayed.

13. The terminal of claim 11, wherein the controller is further configured to obtain a word corresponding to each of the recognized at least one object.

14. The terminal of claim 13, wherein the controller is further configured to:
create a sentence for the description of the displayed image based on the obtained word; and
cause the audio output unit to output the created sentence by the audio corresponding to the determined linguistic habit.

15. The terminal of claim 13, wherein the controller is further configured to cause the display to display the obtained word on a prescribed region of the displayed image.

16. The terminal of claim 11, wherein the controller is further configured to determine the linguistic habit of the user based on at least one selected from the group consisting of a call substance, a text substance, a memo substance, a played content substance, a shot image and a saved image of the user using the terminal.

17. The terminal of claim 11, wherein the controller is further configured to:
obtain a question about the displayed image; and
cause the audio output unit to output an answer to the obtained question by the audio.

18. The terminal of claim 17, wherein the controller is further configured to add a substance questioned over a predetermined count to the description of the image.

19. The terminal of claim 11, wherein the controller is further configured to:
recognize an input received for editing the description of the displayed image;
cause the display to display at least one word included in the description of the displayed image; and
change the description of the image based on an input applied to the displayed at least one word.

20. The terminal of claim 19, wherein the controller is further configured to:
change an order of the description of the displayed image based on the input applied to the displayed at least one word; and
deletes a selected word from the description of the displayed image based on the input applied to the displayed at least one word.
